(19) United States
(12) Patent Application Publication
(10) Pub. No.: US 2025/0052251 A1
(43) Pub. Date: Feb. 13, 2025

(54) AVIATION COMPRESSOR ACTIVE STABILIZATION CONTROL METHOD BASED ON DISTURBANCE OBSERVATION AND COMPENSATION

(71) Applicant: DALIAN UNIVERSITY OF TECHNOLOGY, Dalian (CN)

(72) Inventors: Ximing SUN, Dalian (CN); Chongyi SUN, Dalian (CN); Fuxiang QUAN, Dalian (CN); Wei REN, Dalian (CN); Hongxin LI, Dalian (CN); Zhibo ZHANG, Dalian (CN); Mingsui YANG, Dalian (CN)

(21) Appl. No.: 18/884,715

(22) Filed: Sep. 13, 2024

(30) Foreign Application Priority Data
May 28, 2024 (CN) 202410671036.6

(51) Int. Cl. F04D 27/02; G05D 7/06

(52) U.S. Cl. CPC F04D 27/0253; G05D 7/0623

(57) ABSTRACT

The present invention belongs to the field of aviation compressor control, and relates to an aviation compressor active stabilization control method based on disturbance observation and compensation. Modeling errors and external disturbances of models used in design of a controller are observed, and sub-controllers are individually designed for state variables of interest to compensate for the disturbances, thus to simultaneously solve the problems of rotating stall and surge of an aviation compressor in a variety of complex situations. Partial differential model of the compressor is converted to an ordinary differential equation by Galerkin projection method, partial differential characteristics of the compressor are reserved in the form of disturbances during conversion, and an active stabilization controller of the aviation compressor is designed in combination with disturbance observation and compensation technology, thus to ensure that the models used in the design of the controller have higher accuracy, high robustness and high reliability.

### TECHNICAL FIELD

The present invention belongs to the field of aviation compressor control, and relates to an aviation compressor active stabilization control method based on disturbance observation and compensation.

### BACKGROUND

A compressor is an important part of a gas turbine or an aero-engine; the stability the compressor is directly related to the stability and performance of the aero-engine, and further affects the safety and reliability of an aircraft equipped with the aero-engine. In order to ensure the stability of the compressor during operation, an active stabilization control technology has gradually become a research focus of aviation compressor control methods.

During the operation of an aviation compressor, low-pressure gas will be transformed into high-pressure gas by the compressor, and such a gas flow against a pressure gradient may be accompanied by aerodynamic instability phenomena, so that the compressor will have rotating stall or surge, especially when the compressor is subjected to external disturbances. The aerodynamic instability phenomena such as rotating stall and surge are manifested as different degrees of oscillation in a flow rate and a pressure rise of the air flowing through a compressor system, which seriously affects the operating performance of the compressor and even causes irreversible destructive effects on compressor components. Therefore, it is necessary to design a corresponding controller to ensure that the compressor can maintain stable operation when subjected to external disturbances and avoid the occurrence of aerodynamic instability phenomena, so as to ensure that the compressor can achieve desired performance.

In a traditional aviation compressor stabilization control problem, a method of leaving a sufficient surge margin between a design operating point and a surge line of the compressor is usually adopted, so that the operating point of the compressor can be kept in a stable operating interval when an offset occurs due to external disturbances. Since the surge margin needs to be estimated empirically and the degree of the disturbances subjected by the compressor is not known in advance, the method usually requires the design operating point of the compressor to be far away from the surge line, and such an over-conservative strategy will lead to performance degradation of the compressor. In addition, whether the compressor can be restored to a stable operating state after the rotating stall or surge is not guaranteed in the method. Whereas in the active stabilization control technology, the dynamic performance of the compressor system at the moment of surge is considered, and corresponding stabilization controllers are designed, which is one of the main methods to solve the problem of compressor aerodynamic instability.

In addition, the dynamic performance of the compressor is characterized by strong nonlinearity and strong coupling, and mathematical models thereof are described by partial differential equations. In an existing active stabilization control scheme, in order to apply a variety of mature control technologies to compressor models, the compressor models are often simplified to ordinary differential models, and some partial differential characteristics are ignored; model errors generated in this process will also lead to the failure of a designed active stabilization controller in some operating conditions. At the same time, the rotating stall and surge of the compressor have different laws of development, and the existing control scheme is usually designed for only one of the conditions, which cannot guarantee that the control problems of the rotating stall and surge are solved simultaneously. In order to ensure that the compressor can maintain stable operation in a high performance region in the case that the compressor is subjected to external disturbances, a variety of operating conditions and different instable states, the present invention proposes a compressor active stabilization control method based on disturbance observation and compensation technology design. The proposed method can fully consider the influence of modeling errors and external disturbances on the compressor system in a design process of the active stabilization controller, and can solve the control problems of rotating stall and surge simultaneously, so as to achieve the stabilization control effect of the aviation compressor in a variety of operating conditions.

### SUMMARY

In order to avoid the instability phenomena such as rotating stall and surge due to external disturbances, the present invention proposes an aviation compressor active stabilization control method based on disturbance observation and compensation.

The present invention has the following technical solution:

An aviation compressor active stabilization control method based on disturbance observation and compensation, comprising the following steps:

Step 1: establishing aviation compressor partial differential mathematical models containing external disturbances;

$${l}_{c} \dot{Φ} = - Ψ + \frac{1}{2 π} {\int }_{0}^{2 π} {Ψ}_{c} ( Φ + \frac{\partial \hat{φ}}{\partial η} {\vert}_{η = 0} ) d θ + {d}_{φ} \qquad ( 1 )$$

$$\dot{Ψ} = \frac{1}{4 {B}^{2} {l}_{c}} ( Φ - {Φ}_{T} ( Ψ , u ) ) + {d}_{ψ} \qquad ( 2 )$$

$$Ψ = {Ψ}_{c} ( Φ + \frac{\partial \hat{φ}}{\partial η} {\vert}_{η = 0} ) - {l}_{c} \dot{Φ} - m \frac{\partial \hat{φ}}{\partial t} {\vert}_{η = 0} - \frac{1}{2 a} ( 2 \frac{{\partial }^{2} \hat{φ}}{\partial η \partial t} {\vert}_{η = 0} + \frac{{\partial }^{2} \hat{φ}}{\partial η \partial θ} {\vert}_{η = 0} ) + {d}_{\hat{φ}} \qquad ( 3 )$$

Wherein Φ represents an annulus averaged flow coefficient for flowing through a compressor, Ψ represents an annulus averaged pressure rise coefficient of the compressor, \hat{φ} represents a disturbance velocity potential in a flow channel of the compressor, which is a function of a compressor circumferential angle θ, a compressor axial distance η and time t, and the above are parameters describing an operating state of the compressor; Φ represents a derivative of the annulus averaged flow coefficient Φ, and Ψ represents a derivative of the annulus averaged pressure rise coefficient Ψ; d_{φ}, d_{ψ}, d_{\hat{φ}} and d represent bounded external disturbances subjected by the compressor, wherein d_{φ} and d_{ψ} are functions of the time t, and d_{\hat{φ}} is a function of the time t and the angle θ, and satisfies that d_{φ}(t)=(½π)∫₀^{2π}d_{\hat{φ}}(t, θ)dθ; Φ_{T}(Ψ, u) represents a characteristic of a throttle, which is expressed by the following formula:

$${Φ}_{T} ( Ψ , u ) = ( u + 1 ) γ \sqrt{Ψ} \qquad ( 4 )$$

Wherein u represents an input of a compressor system, and γ represents a positive constant of an inherent parameter of the throttle; Ψ_{c}(x) represents a mapping relationship function of compressor characteristics, which can be written as a cubic polynomial of an independent variable x:

$${Ψ}_{c} ( x ) = {Ψ}_{c 0} + H ( 1 + \frac{3}{2} ( \frac{x}{W} - 1 ) - \frac{1}{2} {( \frac{x}{W} - 1 )}^{3} ) \qquad ( 5 )$$

Wherein Ψ_{c0} represents an ordinate intercept of the cubic function Ψ_{c}(x), H represents half of a height between two extremums of the cubic function, W represents half of a horizontal distance between the two extremums of the cubic function, and a shape of a specific compressor characteristic line is determined through the parameters; in formulas (1)-(3), l_{c} is a parameter representing an equivalent total length of the compressor, a is a parameter representing an averaged lag of a compressor blade air flow, B is a Greitzer-B parameter used for representing a current rotating speed of the compressor, m is a parameter representing a length of a compressor outlet pipe, and the above parameters are all related to compressor size and design performance;

Step 2: establishing aviation compressor ordinary differential models containing disturbances by a Galerkin projection method; first, the disturbance velocity potential \hat{φ} in the flow channel of the compressor is rewritten into a series form by Fourier transform, and the first N terms are reserved as follows:

$$\hat{φ} = {\sum }_{k = 1}^{N} \frac{1}{k} {e}^{k η} {A}_{k} sin ( k θ + {r}_{k} )$$

Wherein Aₖ represents an amplitude of Fourier series of the k^{th} term, and rₖ represents a phase angle of Fourier series of the k^{th} term. The k^{th} order disturbance mode Jₖ and a total disturbance mode J defining the disturbance velocity potential of the compressor are as follows:

$${J}_{k} = \frac{{A}_{k}^{2}}{{W}^{2}} , J = {\sum }_{k = 1}^{N} {J}_{k}$$

Corresponding compressor models are obtained as follows:

$${\dot{J}}_{k} = \frac{3 aHk}{( k + ma ) W} {J}_{k} ( 1 - {( \frac{Φ}{W} - 1 )}^{2} - \frac{1}{4} {J}_{k} ) + {d}_{1 k} , k = 1 , 2 , … , N \qquad ( 6 )$$

$$\dot{Φ} = \frac{H}{{l}_{c}} ( \frac{( - Ψ + {Ψ}_{c 0} )}{H} + 1 + \frac{3}{2} ( \frac{Φ}{W} - 1 ) ( 1 - \frac{1}{2} J ) - \frac{1}{2} {( \frac{Φ}{W} - 1 )}^{3} ) + {d}_{2} \qquad ( 7 )$$

$$\dot{Ψ} = \frac{1}{4 {B}^{2} {l}_{c}} ( Φ - {Φ}_{T} ) + {d}_{3} \qquad ( 8 )$$

Wherein \dot{J}ₖ represents a derivative of the k^{th} order disturbance mode Jₖ, and \dot{Φ} and \dot{Ψ} have the same meaning as defined in formulas (1)-(3); d₁ₖ(k=1,2, . . . , N), d₂ and d₃ represent total disturbances of the models, which can be defined respectively as:

$${d}_{1 k} = {d}_{Jk} + {d}_{\hat{φ} k} \\ {d}_{2} = {d}_{Φ} + \frac{{d}_{φ}}{{l}_{c}} \\ {d}_{3} = {d}_{ψ}$$

Wherein d_{Jk} represents a modeling error affecting the k^{th} order disturbance mode, and d_{Φ} represents a modeling error affecting the annulus averaged flow coefficient Φ; d_{\hat{φ}k}, d_{φ}, and d_{ψ} are parameters representing the external disturbances subjected by the compressor system, which are described by formulas (1)-(3); specifically, d_{\hat{φ}k} represents the k^{th} order component of the disturbance d_{\hat{φ}}, which can be calculated by the following formula:

$${d}_{\hat{φ} k} = \frac{2 ak}{k + ma} \frac{1}{2 π} {\int }_{0}^{2 π} {d}_{\hat{φ}} sin {ζ}_{k} d {ζ}_{k}$$

Wherein ζₖ=kθ+rₖ.

Step 3: establishing aviation compressor models after coordinate transform; the following coordinate transform is selected:

$${Φ}_{s} = Φ - 2 W , {Ψ}_{s} = Ψ - {Ψ}_{c 0} - 2 H , \hat{u} = 2 W - {Φ}_{T}$$

Wherein Φₛ is an annulus averaged flow coefficient after coordinate transform, Ψₛ is a pressure rise coefficient after coordinate transform, and û is a compressor input after coordinate transform; H, W and Ψ_{c0} are compressor characteristics related parameters, which are defined after formula (5). Transformed aviation compressor models can be obtained by the above coordinate transform:

$${\dot{J}}_{k} = \frac{3 aHk}{( k + ma ) W} {J}_{k} ( 1 - {( \frac{{Φ}_{s}}{W} + 1 )}^{2} - \frac{1}{4} {J}_{k} ) + {d}_{1 k} , k = 1 , 2 , … , N \qquad ( 9 )$$

$${\dot{Φ}}_{s} = \frac{H}{{l}_{c}} ( - \frac{{Ψ}_{s}}{H} - 1 + \frac{3}{2} ( \frac{{Φ}_{s}}{W} + 1 ) ( 1 - \frac{1}{2} J ) - \frac{1}{2} {( \frac{{Φ}_{s}}{W} + 1 )}^{3} ) + {d}_{2} \qquad ( 10 )$$

$${\dot{Ψ}}_{s} = \frac{1}{4 {B}^{2} {l}_{c}} ( {Φ}_{s} + \hat{u} ) + {d}_{3} \qquad ( 11 )$$

Step 4: establishing disturbance observers for d₂ and d₃;

$${\dot{\tilde{Φ}}}_{s} = - \frac{1}{{l}_{c}} {Ψ}_{s} + {d}_{s} + {\tilde{d}}_{2} + {k}_{o 11} ( {\tilde{Φ}}_{s} - {Φ}_{s} ) \\ {\dot{\tilde{d}}}_{2} = {k}_{o 12} ( {\tilde{Φ}}_{s} - {Φ}_{s} ) \\ {\dot{\tilde{Ψ}}}_{s} = \frac{1}{4 {B}^{2} {l}_{c}} ( {Φ}_{s} + \hat{u} ) + {\tilde{d}}_{3} + {k}_{o 21} ( {\tilde{Ψ}}_{s} - {Ψ}_{s} ) \\ {\dot{\tilde{d}}}_{3} = {k}_{o 22} ( {\tilde{Ψ}}_{s} - {Ψ}_{s} ) \qquad ( 12 )$$

Wherein \tilde{ϕ}ₛ is an estimated value of the annulus averaged flow coefficient Φₛ, and \tilde{\dot{Φ}}ₛ represents a derivative thereof; \tilde{Ψ}ₛ is an estimated value of the annulus averaged pressure rise coefficient Ψₛ, and \tilde{\dot{Ψ}}ₛ represents a derivative thereof, \tilde{d}₂ is an estimated value of the total disturbance d₂ of the system, and \tilde{\dot{d}}₂ represents a derivative thereof, \tilde{d}₃ is an estimated value of the total disturbance d₃ of the system, and \tilde{\dot{d}}₃ represents a derivative thereof, kₒ₁₁, kₒ₁₂, kₒ₂₁ and kₒ₂₂ are observer parameters, which need to be selected artificially, and the selection of the parameters only needs to ensure that an observer matrix:

$${A}_{o} = [ \begin{matrix}{k}_{o 11} & 1 & 0 & 0 \\ {k}_{o 12} & 0 & 0 & 0 \\ 0 & 0 & {k}_{o 21} & 1 \\ 0 & 0 & {k}_{o 22} & 0\end{matrix} ]$$

is a Hurwitz matrix; dₛ is a nonlinear term, which is defined as:

$${d}_{s} = \frac{H}{{l}_{c}} ( - 1 + \frac{3}{2} ( \frac{{Φ}_{s}}{W} + 1 ) ( 1 - \frac{1}{2} J ) - \frac{1}{2} {( \frac{{Φ}_{s}}{W} + 1 )}^{3} )$$

Step 5: establishing a sub-controller of the disturbance mode J;

$${\hat{Φ}}_{s} = {Φ}_{set} - 2 W + {k}_{1} J \qquad ( 13 )$$

Wherein Φₛₑₜ is a set expected annulus averaged flow coefficient of the compressor; \hat{Φ}ₛ is a virtual control signal, which is also an expected tracking signal of the annulus averaged flow coefficient; k₁ is a controller parameter, and a selection method thereof will be described in step 9;

Step 6: establishing a sub-controller of the annulus averaged flow coefficient; first, a virtual tracking error between the annulus averaged flow coefficient and the expected signal is calculated according to the sub-controller (13) of the disturbance mode designed in step 5:

$${e}_{1} = {Φ}_{s} - {\hat{Φ}}_{s} \qquad ( 14 )$$

Then the sub-controller of the annulus averaged flow coefficient can be written as:

$${\hat{Ψ}}_{s} = {l}_{c} ( {k}_{2} {e}_{1} + {d}_{s} + {\tilde{d}}_{2} ) \qquad ( 15 )$$

Wherein \hat{Ψ}ₛ is a virtual control signal, which is also an expected tracking signal of the annulus averaged pressure rise coefficient; k₂ is a controller parameter, and a selection method thereof will be described in Step 9;

Step 7: establishing a sub-controller of the annulus averaged pressure rise coefficient; first, a virtual tracking error between the annulus averaged pressure rise coefficient and the expected signal is calculated according to the sub-controller (15) of the disturbance mode designed in step 6:

$${e}_{2} = {Ψ}_{s} - {\hat{Ψ}}_{s} \qquad ( 16 )$$

Then the sub-controller of the annulus averaged pressure rise coefficient can be written as:

$$\hat{u} = 4 {B}^{2} {l}_{c} ( {k}_{2} {e}_{1} + {k}_{3} {e}_{2} + {l}_{c} {\dot{d}}_{s} ) - {Φ}_{s} - 4 {B}^{2} {l}_{c} {\tilde{d}}_{3} \qquad ( 17 )$$

Wherein û is a virtual control input of the compressor system, which is defined in step 3; k₃ is a controller parameter, and a selection method thereof will be described in step 9; \dot{d}ₛ represents a derivative of a nonlinear term dₛ, which can be calculated by a numerical differentiator;

Step 8: calculating an actual control input; the virtual control input u can be calculated according to the sub-controllers (13), (15) and (17) as well as the virtual tracking errors (14) and (16); an expression of the actual control input u can be obtained according to the definition of the virtual control input û in step 3:

$$u = ( ( 2 W - \hat{u} ) ) / ( γ \sqrt{Ψ} ) - 1 \qquad ( 18 )$$

Step 9: selecting the controller parameters;

The controller parameters k₁, k₂ and k₃ are required to satisfy that:
(1) k₁>0;
(2) A control matrix

$${A}_{c} = [ \begin{matrix}- {k}_{2} & - 1 / {l}_{c} \\ {k}_{2} & {k}_{3}\end{matrix} ]$$

is a Hurwitz matrix.

The present invention has the following beneficial effects: aiming at the problem that instability phenomena such as rotating stall and surge may occur when an aviation compressor is subjected to external disturbances, the present invention proposes an aviation compressor active stabilization control method based on disturbance observation and compensation. Modeling errors and external disturbances of models used in design of a controller are observed, and sub-controllers are individually designed for state variables of interest to compensate for the disturbances, thus to simultaneously solve the problems of rotating stall and surge of the aviation compressor in a variety of complex situations. Partial differential models of the compressor are converted to ordinary differential equations by a Galerkin projection method, and partial differential characteristics of the compressor are reserved in the form of disturbances during conversion, thus to ensure that the models used in the design of the controller have higher accuracy. A controller parameter selection method is given, so that the method can be implemented in practical engineering.

In the present invention, equivalent transform is conducted to aviation compressor models based on the Galerkin projection method, and an active stabilization controller of the aviation compressor is designed in combination with the disturbance observation and compensation technology, so that the aviation compressor can deal with the stabilization control problems of rotating stall and surge simultaneously in complex conditions such as external disturbances, and has high robustness and reliability. The present invention provides certain experience for the research of the active stabilization control technology of the aviation compressor, and has a relatively high practical engineering application value at the same time.

### DESCRIPTION OF DRAWINGS

FIG. 1 is a schematic diagram of a compressor characteristic line and parameters thereof,

FIG. 2 is a structural schematic diagram of an active stabilization control method based on disturbance observation and compensation;

FIG. 3 shows a process of a compressor system having a rotating stall phenomenon in an initial disturbance condition and exiting from rotating stall after active stabilization control;

FIG. 4 shows a process of a compressor system having a rotating stall phenomenon in an external disturbance condition and exiting from rotating stall after active stabilization control;

FIG. 5 shows a process of a compressor system having a surge phenomenon in an external disturbance condition and exiting from surge after active stabilization control.

### DETAILED DESCRIPTION

A specific embodiment of the present invention is further described below in combination with the drawings and the technical solution.

An aviation compressor active stabilization control method based on disturbance observation and compensation, specifically comprising the following steps:

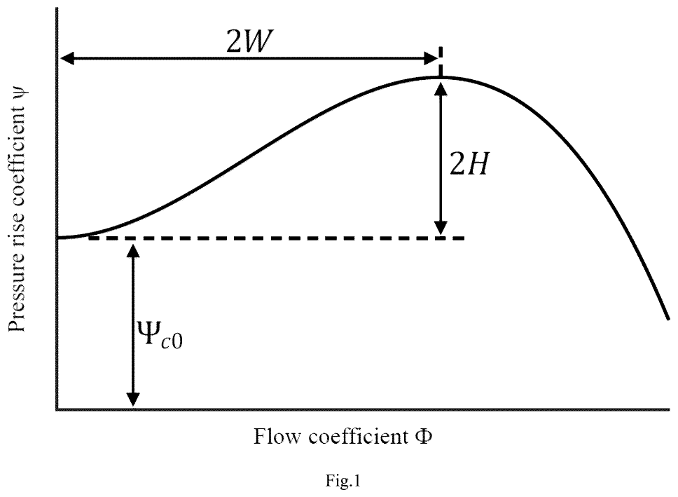

1) Establishing aviation compressor partial differential mathematical models containing external disturbances;

$${{l}_{c} \dot{Φ} = - Ψ + \frac{1}{2 π} {\int }_{0}^{2 π} {Ψ}_{c} ( Φ + \frac{\partial \hat{φ}}{\partial η} \vert}_{η = 0} ) d θ + {d}_{φ} \qquad ( 1 )$$

$$\dot{Ψ} = \frac{1}{4 {B}^{2} {l}_{c}} ( Φ - {Φ}_{T} ( Ψ , u ) ) + {d}_{ψ} \qquad ( 2 )$$

$${{{{Ψ = {Ψ}_{c} ( Φ + \frac{\partial \hat{φ}}{\partial η} \vert}_{η = 0} ) - {l}_{c} \dot{Φ} - m \frac{\partial \hat{φ}}{\partial t} \vert}_{η = 0} - \frac{1}{2 a} ( 2 \frac{{\partial }^{2} \hat{φ}}{\partial η \partial t} \vert}_{η = 0} + \frac{{\partial }^{2} \hat{φ}}{\partial η \partial θ} \vert}_{η = 0} ) + {d}_{\hat{φ}} \qquad ( 3 )$$

Wherein Φ represents an annulus averaged flow coefficient for flowing through a compressor, Ψ represents an annulus averaged pressure rise coefficient of the compressor, \hat{φ} represents a disturbance velocity potential in a flow channel of the compressor, which is a function of a compressor circumferential angle θ, a compressor axial distance η and time t, and the above are parameters describing an operating state of the compressor; \dot{Φ} represents a derivative of the annulus averaged flow coefficient Φ, and \dot{Ψ} represents a derivative of the annulus averaged pressure rise coefficient Ψ; d_{φ}, d_{ψ} and d_{\hat{φ}} represent bounded external disturbances subjected by the compressor, wherein d_{Φ} and d_{ψ} are functions of the time t, and d\hat{φ} is a function of the time t and the angle θ, and satisfies that d_{φ}(t)=(½π)∫₀^{2π}d\hat{φ}(t, θ)dθ; Φ_{T} (Ψ, u) represents a characteristic of a throttle, which is expressed by the following formula:

$${Φ}_{T} ( Ψ , u ) = ( u + 1 ) γ \sqrt{Ψ} \qquad ( 4 )$$

Wherein u represents an input of a compressor system; γ represents a positive constant of an inherent parameter of the throttle, and the inherent parameter γ=0.6565 of the throttle is selected in the embodiment; Ψ_{c}(x) represents a mapping relationship function of compressor characteristics, which can be written as a cubic polynomial of an independent variable x:

$${Ψ}_{c} ( x ) = {Ψ}_{c 0} + H ( 1 + \frac{3}{2} ( \frac{x}{W} - 1 ) - \frac{1}{2} {( \frac{x}{W} - 1 )}^{3} ) \qquad ( 5 )$$

Wherein Ψ_{c0} represents an ordinate intercept of the cubic function Ψ_{c}(x), H represents half of a height between two extremums of the cubic function, W represents half of a horizontal distance between the two extremums of the cubic function, and a shape of a specific compressor characteristic line can be determined through the parameters; referring to FIG. 1, parameters of the compressor characteristic line are respectively selected as follows in the embodiment:

$${Ψ}_{c 0} = 0.3 , W = 0.25 , H = 0.14$$

In formulas (1)-(3), l_{c} is a parameter representing an equivalent total length of the compressor, α is a parameter representing an averaged lag of a compressor blade air flow, B is a Greitzer-B parameter used for representing a current rotating speed of the compressor, m is a parameter representing a length of a compressor outlet pipe, and the above parameters are all related to compressor size and design performance, which are selected as follows in the embodiment:

l_{c}=8.0,α=1/3.5,m=1.75,B=0.40(rotating stall),1.40(surge)

2) Establishing aviation compressor ordinary differential models containing disturbances by a Galerkin projection method;

The disturbance velocity potential \hat{φ} is expressed in a form of Fourier series:

$$\hat{φ} = {\sum }_{k = 1}^{∞} \frac{1}{k} {e}^{k η} {A}_{k} sin ( k θ + {r}_{k} ) \qquad ( 6 )$$

Wherein Aₖ represents an amplitude of Fourier series of the k^{th} term; rₖ represents a phase angle of Fourier series of the k^{th} term. To simplify a calculation process, in the embodiment, only the first term of formula (6) is reserved, i.e., N=1, and an approximate disturbance velocity potential \hat{φ}*

$${\hat{φ}}^{*} = {e}^{η} {A}_{1} sin ( θ + {r}_{1} ) \qquad ( 7 )$$

(7) is substituted into formula (3) to obtain an residue:

$${{{R}_{N} = \frac{\partial {\hat{φ}}^{*}}{\partial t} \vert}_{η = 0} - \frac{\partial \hat{φ}}{\partial t} \vert}_{η = 0}$$

A basis function is selected with: w₀=1, w₁=sin ξ₁, wherein ξ₁=θ+r₁. An inner product is defined:

$$〈 {R}_{N} , {w}_{k} 〉 = \frac{1}{2 π} {\int }_{0}^{2 π} {R}_{N} ( {ζ}_{k} ) {w}_{k} ( {ζ}_{k} ) d {ζ}_{k} , k = 0 , 1 \qquad ( 8 )$$

Letting [symbol] R_{N}, w₀ [symbol] =0 and [symbol] R_{N}, w₁ [symbol] =0, aviation compressor models in an ordinary differential form can be obtained:

[symbol]

$${\dot{J}}_{1} = \frac{3 aH}{( 1 + ma ) W} {J}_{1} ( 1 - {( \frac{Φ}{W} - 1 )}^{2} - \frac{1}{4} {J}_{1} ) + {d}_{11} \qquad ( 9 )$$

$$\dot{Φ} = \frac{H}{{l}_{c}} ( \frac{- Ψ + {Ψ}_{c 0}}{H} + 1 + \frac{3}{2} ( \frac{Φ}{W} - 1 ) ( 1 - \frac{1}{2} J ) - \frac{1}{2} {( \frac{Φ}{W} - 1 )}^{3} ) + {d}_{2} \qquad ( 10 )$$

$$\dot{Ψ} = \frac{1}{4 {B}^{2} {l}_{c}} ( Φ - {Φ}_{T} ) + {d}_{3} \qquad ( 11 )$$

Wherein J₁=A₁²/W², and J=J₁ represents a disturbance mode; J₁ represents a derivative of the first order disturbance mode J₁; d₁₁, d₂ and d₃ represent total disturbances of the models, which can be defined respectively as:

$${d}_{11} = {d}_{J 1} + {d}_{\hat{φ} 1} \\ {d}_{2} = {d}_{Φ} + \frac{{d}_{φ}}{{l}_{c}} \\ {d}_{3} = {d}_{ψ}$$

Wherein d_{J1} represents a modeling error affecting the first order disturbance mode, and d_{Φ} represents a modeling error affecting the annulus averaged flow coefficient Φ; d_{\hat{φ}1}, d_{φ}, and d_{ψ} are parameters representing the external disturbances subjected by the compressor system, which are described by formulas (1)-(3); specifically, d_{\hat{φ}1} represents the first order component of the disturbance d_{\hat{φ}}, which can be calculated by the following formula:

$${d}_{\hat{φ} 1} = \frac{2 a}{1 + ma} \frac{1}{2 π} {\int }_{0}^{2 π} {d}_{\hat{φ}} sin {ζ}_{1} d {ζ}_{1}$$

Wherein ξ₁=θ+r₁.

3) Establishing compressor models after coordinate transform;

Coordinate transform is defined:

$${Φ}_{s} = Φ - 2 W , {Ψ}_{s} = Ψ - {Ψ}_{c 0} - 2 H \qquad ( 12 )$$

Wherein Φₛ is an annulus averaged flow coefficient after coordinate transform, Ψₛ is a pressure rise coefficient after coordinate transform, and û is a compressor input after coordinate transform; H, W and Ψ_{C0} are compressor characteristics related parameters, which are defined after formula (5). According to the coordinate transform described by formula (12), the aviation compressor models (9)-(11) can be rewritten as:

$${\dot{J}}_{1} = \frac{3 aH}{( 1 + ma ) W} {J}_{1} ( 1 - {( \frac{{Φ}_{s}}{W} + 1 )}^{2} - \frac{1}{4} {J}_{1} ) + {d}_{11} \qquad ( 13 )$$

$${\dot{Φ}}_{s} = \frac{H}{{l}_{c}} ( - \frac{{Ψ}_{s}}{h} - 1 + \frac{3}{2} ( \frac{{Φ}_{s}}{W} + 1 ) ( 1 - \frac{1}{2} J ) - \frac{1}{2} {( \frac{{Φ}_{s}}{W} + 1 )}^{3} ) + {d}_{2} \qquad ( 14 )$$

$${\dot{Ψ}}_{s} = \frac{1}{4 {B}^{2} {l}_{c}} ( {Φ}_{s} + \hat{u} ) + {d}_{3} \qquad ( 15 )$$

Wherein û=2W−Φ_{T} represents a system input at new coordinates.

4) Establishing disturbance observers for d₂ and d₃;

$${\dot{\tilde{Φ}}}_{s} = - \frac{1}{{l}_{c}} {Ψ}_{s} + {d}_{s} + {\tilde{d}}_{2} + {k}_{o 11} ( {\tilde{Φ}}_{s} - {Φ}_{s} ) \\ {\dot{\tilde{d}}}_{2} = {k}_{o 12} ( {\tilde{Φ}}_{s} - {Φ}_{s} ) \\ {\dot{\tilde{Ψ}}}_{s} = \frac{1}{4 {B}^{2} {l}_{c}} ( {Φ}_{s} + \hat{u} ) + {\tilde{d}}_{3} + {k}_{o 21} ( {\tilde{Ψ}}_{s} - {Ψ}_{s} ) \\ {\dot{\tilde{d}}}_{3} = {k}_{o 22} ( {\tilde{Ψ}}_{s} - {Ψ}_{s} ) \qquad ( 16 )$$

Wherein \tilde{Φ}ₛ is an estimated value of the annulus averaged flow coefficient Φₛ, and \tilde{\dot{Φ}}ₛ represents a derivative thereof; \tilde{Ψ}ₛ is an estimated value of the annulus averaged pressure rise coefficient Ψₛ, and \tilde{\dot{Φ}}ₛ represents a derivative thereof, \tilde{d}₂ is an estimated value of the total disturbance d₂ of the system, and \tilde{\dot{d}}₂ represents a derivative thereof, \tilde{d}₃ is an estimated value of the total disturbance d₃ of the system, and \tilde{\dot{d}}₃ represents a derivative thereof, dₛ can be calculated by the following formula:

$${d}_{s} = \frac{H}{{l}_{c}} ( - 1 + \frac{3}{2} ( \frac{{Φ}_{s}}{W} + 1 ) ( 1 - \frac{1}{2} J ) - \frac{1}{2} {( \frac{{Φ}_{s}}{W} + 1 )}^{3} )$$

kₒ₁₁, kₒₗ₂, kₒ₂₁ and kₒ₂₂ are observer parameters, which need to be selected artificially, and the parameters are selected as follows in the embodiment:

$${k}_{o 11} = - 2. , {k}_{o 12} = - 1. , {k}_{o 21} = - 2. , {k}_{o 22} = - 1.$$

It is easy to verify that an observer matrix:

$${A}_{o} = [ \begin{matrix}{k}_{o 11} & 1 & 0 & 0 \\ {k}_{o 12} & 0 & 0 & 0 \\ 0 & 0 & {k}_{o 21} & 1 \\ 0 & 0 & {k}_{o 22} & 0\end{matrix} ]$$

is a Hurwitz matrix.

5) Establishing a sub-controller of the disturbance mode J;

$${\hat{Φ}}_{s} = {Φ}_{set} - 2 W + {k}_{1} J \qquad ( 17 )$$

Wherein Φₛₑₜ is a set expected annulus averaged flow coefficient of the compressor; \hat{Φ}ₛ is a virtual control signal, which is also an expected tracking signal of the annulus averaged flow coefficient; k₁ is a controller parameter, which is selected in step 9).
6) Establishing a sub-controller of the annulus averaged flow coefficient; first, a virtual tracking error between the annulus averaged flow coefficient and the expected signal is calculated according to the sub-controller (17) of the disturbance mode designed in step (5):

$${e}_{1} = {Φ}_{s} - {\hat{Φ}}_{s} \qquad ( 18 )$$

Then the sub-controller of the annulus averaged flow coefficient can be written as:

$${\hat{Ψ}}_{s} = {l}_{c} ( {k}_{2} {e}_{1} + {d}_{s} + {\tilde{d}}_{2} ) \qquad ( 19 )$$

Wherein \hat{Ψ}ₛ is a virtual control signal, which is also an expected tracking signal of the annulus averaged pressure rise coefficient; k₂ is a controller parameter, and a selection method thereof will be described in step 9);

7) Establishing a sub-controller of the annulus averaged pressure rise coefficient; first, a virtual tracking error between the annulus averaged pressure rise coefficient and the expected signal is calculated according to the sub-controller (19) of the disturbance mode designed in step 6):

$${e}_{2} = {Ψ}_{s} - {\hat{Ψ}}_{s} \qquad ( 20 )$$

Then the sub-controller of the annulus averaged pressure rise coefficient can be written as:

$$\hat{u} = 4 {B}^{2} {l}_{c} ( {k}_{2} {e}_{1} + {k}_{3} {e}_{2} + {l}_{c} {\dot{d}}_{s} ) - {Φ}_{s} - 4 {B}^{2} {l}_{c} {\tilde{d}}_{3} \qquad ( 21 )$$

Wherein û is a virtual control input of the compressor system, which is defined in step (3); k₃ is a controller parameter, and a selection method thereof will be described in step 9); \dot{d}ₛ represents a derivative of a nonlinear term dₛ, which can be calculated by a numerical differentiator;

8) Calculating an actual control input; the virtual control input û can be calculated according to the sub-controllers (17), (19) and (21) as well as the virtual tracking errors (18) and (20); an expression of the actual control input u can be obtained according to the definition of the virtual control input û in step (3):

$$u = ( ( 2 W - \hat{u} ) ) / ( γ \sqrt{Ψ} ) - 1 \qquad ( 22 )$$

9) Selecting the controller parameters;

In the embodiment, a controller parameter of k₁=0.20>0 is taken, and at the same time:

k₂=0.0246,k₃=−0.272

It is easy to verify that a controller matrix:

$${A}_{c} = [ \begin{matrix}- {k}_{2} & - 1 / {l}_{c} \\ {k}_{2} & {k}_{3}\end{matrix} ]$$

is a Hurwitz matrix.

10) Simulation and result analysis

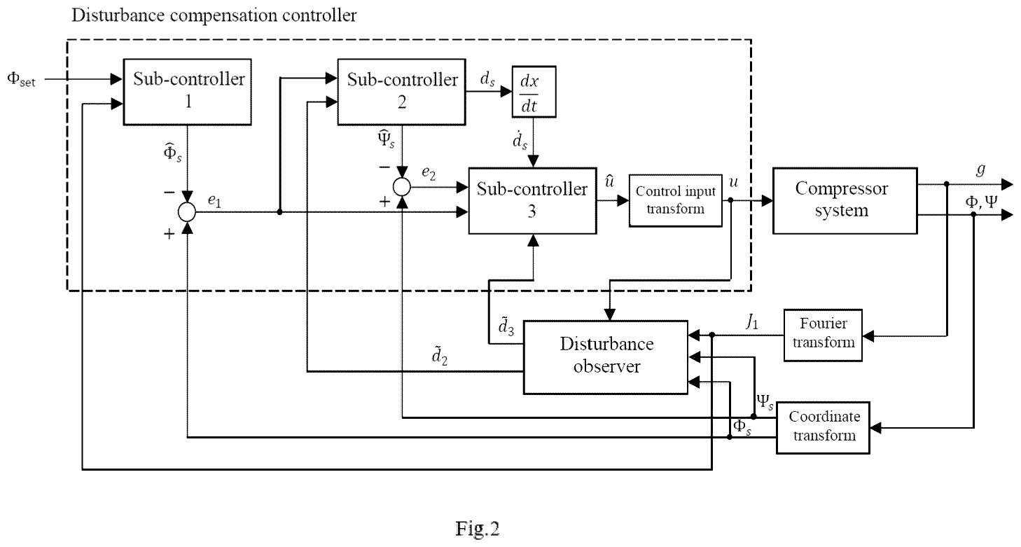

The aviation compressor models are established in Simulink, state variables input to and output by an aviation compressor are connected to the disturbance observers, state variables output by the models and disturbance observations output by the disturbance observers are connected to the input of each sub-controller, and the output of each controller is connect to the input of the aviation compressor to form a close loop. A structural block diagram of a control system is shown in FIG. 2. In the embodiment, an initial condition of the compressor is selected and an operating point is set as:

Φ₀=0.50,Ψ₀=0.58,Φₛₑₜ=0.50,Ψₛₑₜ=0.58

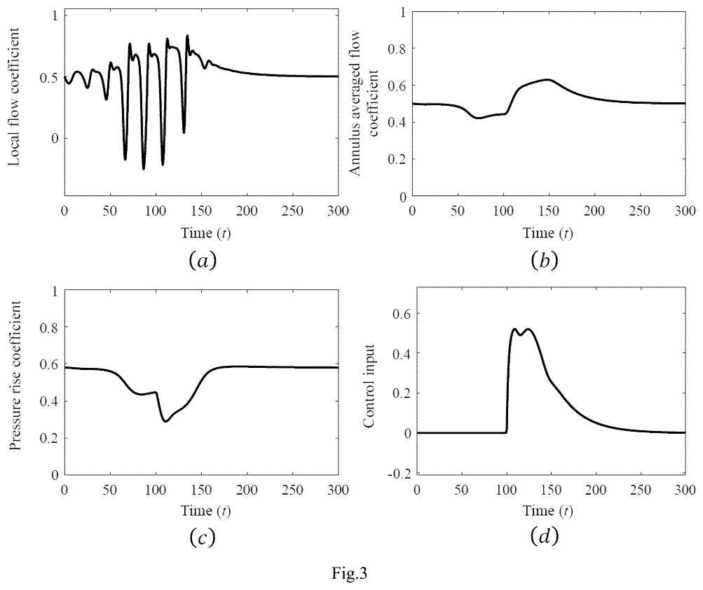

Results of FIG. 3 to FIG. 5 can be obtained by conducting simulations in different conditions such as initial disturbance and external disturbances.

FIG. 3 describes a process of a compressor system having a rotating stall phenomenon in an initial disturbance condition and exiting from rotating stall after active stabilization control. By setting uneven distribution of an initial local flow coefficient in a simulation model, rotating stall of the compressor system can be realized in an uncontrolled range of t∈[0,100], which is manifested as violent oscillation of the local flow coefficient and deviation of the annulus averaged flow coefficient and pressure rise coefficient from initial equilibrium points to rotating stall operating points at other positions. When a controller is introduced at t=100, it can be observed that under the action of the active stabilization controller proposed by the present invention, the local flow coefficient of the compressor system is gradually restored to a steady state, and the annulus averaged flow coefficient and pressure rise coefficient are also gradually restored to set values.

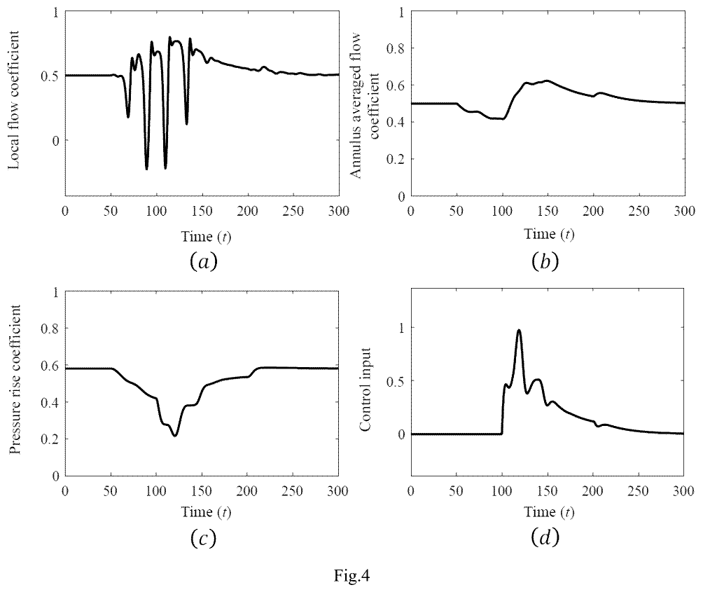

FIG. 4 describes a process of a compressor system having a rotating stall phenomenon in an external disturbance condition and exiting from rotating stall after active stabilization control. External disturbances are introduced to the compressor system at t=50, and the compressor enters a rotating stall state similar to FIG. 3. After a controller is introduced at t=100, the compressor can be quickly restored from the rotating stall state to a normal operating state. After the external disturbances are removed at t=200, the compressor can also be quickly restored to a set operating state and operate stably.

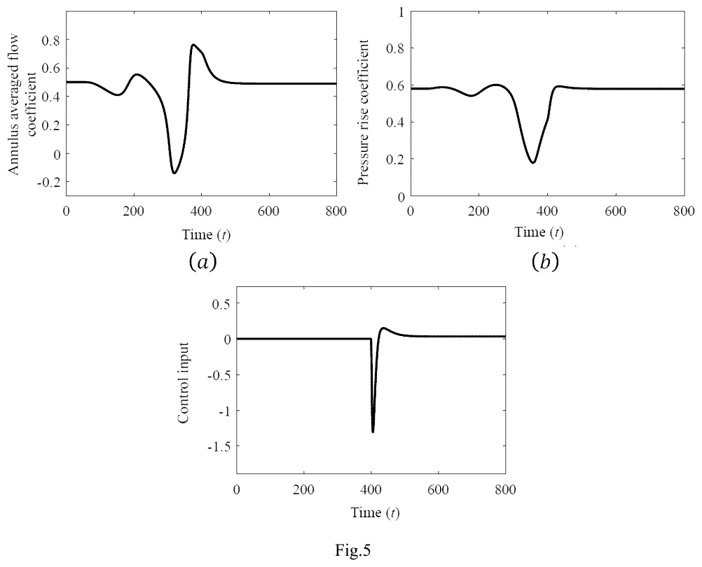

FIG. 5 describes a process of a compressor system having a surge phenomenon in an external disturbance condition and exiting from surge after active stabilization control. In a range of t∈ [0,400], the compressor has a surge phenomenon under the influence of the external disturbances, which is manifested as annulus averaged flow and pressure rise coefficients oscillating at a frequency lower than that of the rotating stall, while the local flow coefficient keeps in line with the annulus averaged flow coefficient (therefore, the local flow coefficient is not reflected in the figure). After the controller is introduced at t=400, it can be seen that the annulus averaged flow coefficient and pressure rise coefficient quickly exit from the oscillating state and stabilize at a set operating point, which indicates that the active stabilization controller proposed can effectively solve the surge problem of the compressor.

The above results show that after the method of the present invention is applied, the aviation compressor can be quickly restored to a stable operating state from rotating stall and surge states caused by the initial disturbance and external disturbances. To sum up, the method proposed by the present invention achieves a good application effect.

1. An aviation compressor active stabilization control method based on disturbance observation and compensation, comprising the following steps:
step 1: establishing aviation compressor partial differential mathematical models containing external disturbances;
$${{l}_{c} \dot{Φ} = - Ψ + \frac{1}{2 π} {\int }_{0}^{2 π} {Ψ}_{c} ( Φ + \frac{\partial \hat{φ}}{\partial η} \vert}_{η = 0} ) d θ + {d}_{φ} \qquad ( 1 )$$
$$\dot{Ψ} = \frac{1}{4 {B}^{2} {l}_{c}} ( Φ - {Φ}_{T} ( Ψ , u ) ) + {d}_{ψ} \qquad ( 2 )$$
$${{{{Ψ = {Ψ}_{c} ( Φ + \frac{\partial \hat{φ}}{\partial η} \vert}_{η = 0} ) - {l}_{c} \dot{Φ} - m \frac{\partial \hat{φ}}{\partial t} \vert}_{η = 0} - \frac{1}{2 a} ( 2 \frac{{\partial }^{2} \hat{φ}}{\partial η \partial t} \vert}_{η = 0} + \frac{{\partial }^{2} \hat{φ}}{\partial η \partial θ} \vert}_{η = 0} ) + {d}_{\hat{φ}} \qquad ( 3 )$$
wherein Φ represents an annulus averaged flow coefficient for flowing through a compressor, Ψ represents an annulus averaged pressure rise coefficient of the compressor, \hat{φ} represents a disturbance velocity potential in a flow channel of the compressor, which is a function of a compressor circumferential angle θ, a compressor axial distance η and time t, and the above are parameters describing an operating state of the compressor; Φ represents a derivative of the annulus averaged flow coefficient Φ, and \dot{Ψ} represents a derivative of the annulus averaged pressure rise coefficient Ψ; d_{φ}, d_{ψ}, d_{\hat{φ}} and d represent bounded external disturbances subjected by the compressor, wherein d_{φ} represents an external disturbance affecting the annulus averaged flow coefficient Φ, d_{ψ} represents an external disturbance affecting the annulus averaged pressure rise coefficient Ψ, both of which are functions of the time t, and d_{\hat{φ}} represents an external disturbance affecting the disturbance velocity potential \hat{φ}, is a function of the time t and the angle θ, and satisfies that d_{φ}(t)=(½π)∫₀^{2π}d_{\hat{φ}}(t, θ)dθ; Φ_{T}(Ψ, u) represents a characteristic of a throttle, which is expressed by the following formula:
$${Φ}_{T} ( Ψ , u ) = ( u + 1 ) γ \sqrt{Ψ} \qquad ( 4 )$$
wherein u represents an input of a compressor system, and γ represents a positive constant of an inherent parameter of the throttle; Ψ_{c}(x) represents a mapping relationship function of compressor characteristics, which is written as a cubic polynomial of an independent variable x:
$${Ψ}_{c} ( x ) = {Ψ}_{c 0} + H ( 1 + \frac{3}{2} ( \frac{x}{W} - 1 ) - \frac{1}{2} {( \frac{x}{W} - 1 )}^{3} ) \qquad ( 5 )$$
wherein Ψ_{c0} represents an ordinate intercept of the cubic function Ψ_{c} (x), H represents half of a height between two extremums of the cubic function, W represents half of a horizontal distance between the two extremums of the cubic function, and a shape of a specific compressor characteristic line can be determined through the parameters; in formulas (1)-(3), l_{c} is a parameter representing an equivalent total length of the compressor, α is a parameter representing an averaged lag of a compressor blade air flow, B is a Greitzer-B parameter used for representing a current rotating speed of the compressor, m is a parameter representing a length of a compressor outlet pipe, and the above parameters are all related to compressor size and design performance;
step 2: establishing aviation compressor ordinary differential models containing disturbances by a Galerkin projection method; first, the disturbance velocity potential \hat{φ} in the flow channel of the compressor is rewritten into a series form by Fourier transform, and the first N terms are reserved as follows:
$$\hat{φ} = {\sum }_{k = 1}^{N} \frac{1}{k} {e}^{k η} {A}_{k} sin ( k θ + {r}_{k} )$$
wherein Aₖ represents an amplitude of Fourier series of the k^{th} term, and rₖ represents a phase angle of Fourier series of the k^{th} term; the k^{th} order disturbance mode Jₖ and a total disturbance mode J defining the disturbance velocity potential of the compressor are as follows:
$${J}_{k} = \frac{{A}_{k}^{2}}{{W}^{2}} , J = {\sum }_{k = 1}^{N} {J}_{k}$$
corresponding compressor models are obtained as follows:
$${\dot{J}}_{k} = \frac{3 aHk}{( k + ma ) W} {J}_{k} ( 1 - {( \frac{Φ}{W} - 1 )}^{2} - \frac{1}{4} {J}_{k} ) + {d}_{1 k} , k = 1 , 2 , … , N \qquad ( 6 )$$
$$\dot{Φ} = \frac{H}{{l}_{c}} ( \frac{( - Ψ + {Ψ}_{c 0} )}{H} + 1 + \frac{3}{2} ( \frac{Φ}{W} - 1 ) ( 1 - \frac{1}{2} J ) - \frac{1}{2} {( \frac{Φ}{W} - 1 )}^{3} ) + {d}_{2} \qquad ( 7 )$$
$$\dot{Ψ} = \frac{1}{4 {B}^{2} {l}_{c}} ( Φ - {Φ}_{T} ) + {d}_{3} \qquad ( 8 )$$
wherein \dot{J}ₖ represents a derivative of the k^{th} order disturbance mode Jₖ, and \dot{Φ} and \dot{Ψ} have the same meaning as defined in formulas (1)-(3); d₁ₖ(k=1,2, . . . , N), d₂ and d₃ represent total disturbances of the models, which are defined respectively as:
$${d}_{1 k} = {d}_{jk} + {d}_{\hat{φ} k}$$
$${d}_{2} = {d}_{Φ} + \frac{{d}_{φ}}{{l}_{c}}$$
$${d}_{3} = {d}_{ψ}$$
wherein d_{Jk} represents a modeling error affecting the k^{th} order disturbance mode, and d_{Φ} represents a modeling error affecting the annulus averaged flow coefficient Φ; d_{\hat{φ}k}, d_{φ}, and d_{ψ} are parameters representing the external disturbances subjected by the compressor system, which are described by formulas (1)-(3); d_{\hat{φ}k} represents the k^{th} order component of the disturbance d_{\hat{φ}}, which is calculated by the following formula:
$${d}_{\hat{φ} k} = \frac{2 ak}{k + ma} \frac{1}{2 π} {\int }_{0}^{2 π} {d}_{\hat{φ}} sin {ζ}_{k} d {ζ}_{k}$$
wherein ξₖ=kθ+rₖ;
step 3: establishing aviation compressor models after coordinate transform; the following coordinate transform is selected:
$${Φ}_{s} = Φ - 2 W , {Ψ}_{s} = Ψ - {Ψ}_{c 0} - 2 H , \hat{u} = 2 W - {Φ}_{T}$$
wherein Φₛ is an annulus averaged flow coefficient after coordinate transform, Ψₛ is a pressure rise coefficient after coordinate transform, and û is a compressor input after coordinate transform; H, W and Ψ_{c0} are compressor characteristics related parameters; transformed aviation compressor models are obtained by the above coordinate transform:
$${\dot{J}}_{k} = \frac{3 aHk}{( k + ma ) W} {J}_{k} ( 1 - {( \frac{{Φ}_{s}}{W} + 1 )}^{2} - \frac{1}{4} {J}_{k} ) + {d}_{1 k} , k = 1 , 2 , … , N \qquad ( 9 )$$
$${\dot{Φ}}_{s} = \frac{H}{{l}_{c}} ( - \frac{{Ψ}_{s}}{H} - 1 + \frac{3}{2} ( \frac{{Φ}_{s}}{W} + 1 ) ( 1 - \frac{1}{2} J ) - \frac{1}{2} {( \frac{{Φ}_{s}}{W} + 1 )}^{3} ) + {d}_{2} \qquad ( 10 )$$
$${\dot{Ψ}}_{s} = \frac{1}{4 {B}^{2} {l}_{c}} ( {Φ}_{s} + \hat{u} ) + {d}_{3} \qquad ( 11 )$$
step 4: establishing disturbance observers for d₂ and d₃;
$${\dot{\tilde{Φ}}}_{s} = - \frac{1}{{l}_{c}} {Ψ}_{s} + {d}_{s} + {\tilde{d}}_{2} + {k}_{o 11} ( {\tilde{Φ}}_{s} - {Φ}_{s} ) \qquad ( 12 )$$
$${\dot{\tilde{d}}}_{2} = {k}_{o 12} ( {\tilde{Φ}}_{s} - {Φ}_{s} )$$
$${\dot{\tilde{Ψ}}}_{s} = \frac{1}{4 {B}^{2} {l}_{c}} ( {Φ}_{s} + \hat{u} ) + {\tilde{d}}_{3} + {k}_{o 21} ( {\tilde{Ψ}}_{s} - {Ψ}_{s} )$$
$${\dot{\tilde{d}}}_{3} = {k}_{o 22} ( {\tilde{Ψ}}_{s} - {Ψ}_{s} )$$
wherein \tilde{Φ}S is an estimated value of the annulus averaged flow coefficient Φ s, and \tilde{\dot{Φ}}ₛ represents a derivative thereof; \tilde{Ψ}s is an estimated value of the annulus averaged pressure rise coefficient Ψₛ, and \tilde{\dot{Ψ}}ₛ represents a derivative thereof, \tilde{d}₂ is an estimated value of the total disturbance d₂ of the system, and \tilde{\dot{d}}₂ represents a derivative thereof, \tilde{d}₃ is an estimated value of the total disturbance d₃ of the system, and \tilde{\dot{d}}₃ represents a derivative thereof; kₒ₁₁, kₒ₁₂, kₒ₂₁ and kₒ₂₂ are observer parameters, which need to be selected artificially, and the selection of the parameters needs to ensure that an observer matrix:
$${A}_{o} = [ \begin{matrix}{k}_{o 11} & 1 & 0 & 0 \\ {k}_{o 12} & 0 & 0 & 0 \\ 0 & 0 & {k}_{o 21} & 1 \\ 0 & 0 & {k}_{o 22} & 0\end{matrix} ]$$
is a Hurwitz matrix; dₛ is a nonlinear term, which is defined as:
$${d}_{s} = \frac{H}{{l}_{c}} ( - 1 + \frac{3}{2} ( \frac{{Φ}_{s}}{W} + 1 ) ( 1 - \frac{1}{2} J ) - \frac{1}{2} {( \frac{{Φ}_{s}}{W} + 1 )}^{3} )$$
step 5: establishing a sub-controller of the disturbance mode J;
$${\hat{Φ}}_{s} = {Φ}_{set} - 2 W + {k}_{1} J \qquad ( 13 )$$
wherein Φₛₑₜ is a set expected annulus averaged flow coefficient of the compressor; \hat{Φ}ₛ is a virtual control signal, which is also an expected tracking signal of the annulus averaged flow coefficient; k₁ is a controller parameter;
step 6: establishing a sub-controller of the annulus averaged flow coefficient; first, a virtual tracking error between the annulus averaged flow coefficient and the expected signal is calculated according to the sub-controller (13) of the disturbance mode designed in step 5:
$${e}_{1} = {Φ}_{s} - {\hat{Φ}}_{s} \qquad ( 14 )$$
then the sub-controller of the annulus averaged flow coefficient is written as:
$${\hat{Ψ}}_{s} = {l}_{c} ( {k}_{2} {e}_{1} + {d}_{s} + {\tilde{d}}_{2} ) \qquad ( 15 )$$
wherein \hat{Ψ}ₛ is a virtual control signal, which is also an expected tracking signal of the annulus averaged pressure rise coefficient; k₂ is a controller parameter;
step 7: establishing a sub-controller of the annulus averaged pressure rise coefficient; first, a virtual tracking error between the annulus averaged pressure rise coefficient and the expected signal is calculated according to the sub-controller (15) of the disturbance mode designed in step 6:
$${e}_{2} = {Ψ}_{s} - {\hat{Ψ}}_{s} \qquad ( 16 )$$
then the sub-controller of the annulus averaged pressure rise coefficient is written as:
$$\hat{u} = 4 {B}^{2} {l}_{c} ( {k}_{2} {e}_{1} + {k}_{3} {e}_{2} + {l}_{c} {\dot{d}}_{s} ) - {Φ}_{s} - 4 {B}^{2} {l}_{c} {\tilde{d}}_{3} \qquad ( 17 )$$
wherein û is a virtual control input of the compressor system, which is defined in step 3; k₃ is a controller parameter; \dot{d}ₛ represents a derivative of a nonlinear term dₛ, which is calculated by a numerical differentiator;
step 8: calculating an actual control input; the virtual control input u is calculated according to the sub-controllers (13), (15) and (17) as well as the virtual tracking errors (14) and (16); an expression of the actual control input u is obtained according to the definition of the virtual control input û in step 3:
$$u = ( ( 2 W - \hat{u} ) ) / ( γ \sqrt{Ψ} ) - 1 \qquad ( 18 )$$
step 9: selecting the controller parameters;
the controller parameters k₁, k₂ and k₃ are required to satisfy that:
(1) k₁>0;
(2) a control matrix
$${A}_{c} = [ \begin{matrix}- {k}_{2} & - 1 / {l}_{c} \\ {k}_{2} & {k}_{3}\end{matrix} ]$$
is a Hurwitz matrix.
